(19) United States
(12) Patent Application Publication
(10) Pub. No.: US 2003/0188690 A1
(43) Pub. Date: Oct. 9, 2003

(54) Cat litter box

(75) Inventor: Jo Ann D. Zabik, Elk Grove, CA (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: GHL INTERNATIONAL, INC., Cedarburg, WI

(21) Appl. No.: 10/408,616

(22) Filed: Apr. 7, 2003

Related U.S. Application Data
(60) Provisional application No. 60/370,875, filed on Apr. 7, 2002.

(51) Int. Cl. A01K 29/00

(52) U.S. Cl. 119/165

(57) ABSTRACT

A cat litter box includes a floor and first, second, and third sidewalls that extend upwardly from the floor. The sidewalls are in an at least generally triangular arrangement with the first sidewall being generally perpendicular to the second sidewall so as to permit the cat litter box to be placed in a corner of a room. The first sidewall is disposed adjacent to and parallel with one of the walls of the room and the second sidewall is disposed adjacent to and parallel with another one of the walls of the room. The cat litter box also includes a low and wide entranceway that extends outwardly from the third sidewall.

### CROSS-REFERENCE TO RELATED APPLICATION

This application claims priority under 35 U.S.C. § 119(e) to U.S. Provisional Patent Application No. 60/370,875, filed Apr. 7, 2002, the entire disclosure of which is incorporated herein by reference.

### FILED OF THE INVENTION

The present invention is directed to a cat litter box and more particularly to a cat litter box that is well-suited for placement in a corner of a room.

### BACKGROUND OF THE INVENTION

Cat litter boxes typically include a rectangular floor and four upwardly extending sidewalls. Some cat litter boxes also include a cover or lid for deflecting cat litter displaced above the sidewalls. However, some cats refuse to use covered litter boxes. Additionally, lids typically fail to deflect all cat litter, resulting in cat litter landing outside of the box and scattering on the floor adjacent the box.

Normal use of cat litter boxes involves the deposition of cat litter into the box. The cat or cats use the box for a given amount of time. Then, the cat litter is removed from the box, typically by lifting the box, turning it, and then pouring the litter out of the box, over the edge of one or more of the side walls. Some cat litter often spills onto the floor during this process, leading to more work for the cat owner.

Most cat litter boxes have a flat bottom that rests directly on the floor or is positioned close to the floor. This characteristic can lead to further problems. Additionally, as cats age or become infirm, it can become difficult for them to enter and exit a cat litter box. This can lead to cats not wanting to use a cat litter box. Instead, they use a more convenient location, such as a floor, leading to damage of flooring, odors, and other undesirable effects. Some “finicky” cats also simply refuse to use a cat litter box, particularly when urinating. They instead urinate just outside the litter box. Urine then runs under the box and soaks the bottom of the box where it is difficult and inconvenient to clean the box and floor. For example, the box must be lifted and then its underside must be cleaned while the box is elevated. In addition, because air cannot get between the flat bottom periphery of the box and the floor, the box the floor may remain damp for a long time, leading to floor damage and bacteria growth.

FIGS. 1-3 show a prior art corner cat litter box 10 having the limitations described above. Box 10 is configured for placement in a corner and, therefore, is generally triangular in shape. Litter box 10 includes a bottom portion 12 and a cover 14 mountable on the bottom portion 12. Cover 14 includes two sidewalls 16 and 18 and a front wall 20 that spans from one sidewall 16 to the other sidewall 18. The bottom portion 12 includes two sidewalls 22 and 24 and a front wall 26 that spans from one sidewall 22 to the other sidewall 24. The front walls 20 and 26 have cutouts that meet to form an entranceway 28 through which a cat can enter and exit. In one implementation of the cat litter box 10 shown in these figures, a door (not shown) is hingedly attached to an upper edge 30 of the entranceway 28, virtually completely enclosing the cat litter box 10. While cat owners might find this feature desirable, most cats do not like to have their view blocked when they are in such a vulnerable position. Because the cat litter box 10 lacks a true handle, the box 10 is not easily lifted. Furthermore, the bottom 12 of the box 10 must be balanced while the box 10 is elevated, or it must be turned over as the underside 32 is cleaned. Balancing the box 10 is difficult because it lacks a pivot point.

FIG. 2 shows an underside 32 of the floor 19 of the prior art corner cat litter box 10. The underside 32 includes a raised, outer edge 34, which contacts a room's floor 36 on which the cat litter box 10 is positioned, and an inner area 38, which is elevated off of the floor 19. This underside 32 configuration of the prior art box 10 has several drawbacks. First, the strength of the underside 32 is relatively low. When the cat litter box 10 is filled with cat litter and a large 12 to 20 pound cat enters the box 10, the inner area 38 will bend, thereby stressing and weakening the underside 32 of the cat litter box 10. Second, where a cat urinates outside of and next to the cat litter box 10, urine can seep under the box 10 and can travel along the outer edge 34 to coat a relatively large surface of the underside 32 with urine. This makes cleaning the underside 32 of the cat litter box 10 difficult and inconvenient. The underside of the box and floor are also slow to dry due to poor circulation between the box and the floor. The box 10 must be lifted to clean the underside 32. Additionally, the floor 19 must be cleaned while the box 10 is elevated and/or balanced.

Therefore, what is needed is an improved cat litter box that does not require a lid or a cover, but that still leads to the deflection of cat litter.

What is also needed is an improved cat litter box that facilitates pouring cat litter out of the box when it is desired to remove cat litter from the box.

It would additionally be desirable to provide a cat litter box that is easily entered and exited.

What is also needed is a cat litter box that avoids the need to clean its underside if a cat urinates next to the box.

### SUMMARY OF THE INVENTION

The present invention provides a cat litter box that includes a floor and first, second, and third sidewalls that extend upwardly from the floor. The sidewalls are in an at least generally triangular arrangement with the first sidewall being generally perpendicular to the second sidewall so as to permit the cat litter box to be placed in a corner of a room with the first sidewall disposed adjacent to and parallel with one of the walls of the room and the second sidewall disposed adjacent to and parallel with another one of the walls of the room. The cat litter box also includes an entranceway that extends outwardly from the third sidewall.

The invention also provides a cat litter box for placement in a corner of a room and including a floor and a pair of sidewalls that extend upwardly from the floor with one of the sidewalls being generally perpendicular to the other one of the sidewalls. The cat litter box also includes a front wall that extends from one of the sidewalls to the other one of the sidewalls and an ingress and egress platform that extends outwardly from the front wall.

Also provided is a cat litter box for placement between a first wall and a second wall of a room that define a corner of the room. The cat litter box includes a floor that has a plurality of legs that space the box from the floor of the room and a plurality of sidewalls extending upwardly from the floor of the cat litter box to form an enclosure.

In addition, a cat litter box for placement in a corner of a room is provided that has a floor and a pair of sidewalls that extend outwardly from the floor with one of the sidewalls being generally perpendicular to the other one of the sidewalls. Each sidewall has a lip that extends outwardly from the sidewall. The cat litter box additionally includes a front wall that extends from one of the sidewalls to the other one of the sidewalls and an ingress and egress platform that extends outwardly from the front wall.

Additionally provided is a cat litter box that is disposed between a first wall and a second wall of a room that define a corner of the room. The cat litter box includes a floor having a plurality of legs that space the floor of the box from a floor of the room and a pair of sidewalls that extend outwardly from the floor with one of the sidewalls being generally parallel to the first wall of the room and generally perpendicular to the other one of the sidewalls and the other one of the sidewalls being generally parallel to one the second wall of the room, and a curved front wall that extends from one of the sidewalls to the other one of the sidewalls. The cat litter box also includes an ingress and egress platform that extends outwardly from the front wall with the platform having an outwardly extending lip that defines a handle for lifting the cat litter box.

Features and advantages of the present invention include one or more of the following:

a cat litter box that can be used without a cover or a lid and that deflects cat litter back into the cat litter box when cat litter is dispersed above a wall of the cat litter box;

a cat litter box that facilitates pouring cat litter out of the box when it is desired to remove cat litter from the box;

a cat litter box that is easier for cats to enter and exit due to a low and wide opening with an angled lip;

a cat litter box that avoids the need to clean its underside where a cat urinates next to the box; to provide a cat litter box that is easy to manufacture, lightweight, rugged, durable, reliable, economical to manufacture, and/or which is easy to assemble and use.

Various other features and advantages of the present invention will be made apparent from the following detailed description and the drawings.

### BRIEF DESCRIPTION OF THE DRAWINGS

Preferred exemplary embodiments of the invention are illustrated in the accompanying drawings in which like reference numerals represent like parts throughout and in which:

FIG. 1 is a perspective view of a prior art cat litter box;

FIG. 2 is a perspective view of the underside of the prior art cat litter box;

FIG. 3 is an exploded view of the prior art cat litter box;

FIG. 4 is a perspective view of a cat litter box made in accordance with the invention and that is disposed in a corner of a room;

FIG. 5 is a perspective view of a rear corner of the cat litter box of FIG. 4;

FIG. 6 is a perspective view of the cat litter box of FIG. 4 showing one side of the box;

FIG. 7 is a perspective view of the cat litter box of FIG. 4 showing the other side of the box;

FIG. 8 is a bottom plan view of the cat litter box of FIG. 4;

FIG. 9 is a perspective view of the bottom of the cat litter box of FIG. 4;

FIG. 10 is a front perspective view of the bottom of the cat litter box of FIG. 4;

FIG. 11 is a front elevation view of the bottom of the cat litter box of FIG. 4;

FIG. 12 is an enlarged fragmentary elevation view depicting an entry opening of the cat litter box of FIG. 4 in more detail taken from a perspective outside of the cat litter box;

FIG. 13 is an enlarged fragmentary elevation view depicting the entry opening of the cat litter box of FIG. 4 in more detail taken from a perspective outside of the cat litter box;

FIG. 14 is a fragmentary side view of the cat litter box of FIG. 4;

FIG. 15 is a fragmentary perspective view depicting the entry opening of the cat litter box of FIG. 4 in more detail taken from a perspective outside of the cat litter box;

FIG. 16 is a fragmentary bottom view of the entry opening of the cat litter box of FIG. 4; and

FIG. 17 is a fragmentary perspective view depicting the entry opening of the cat litter box of FIG. 4 in more detail taken from a perspective inside of the cat litter box.

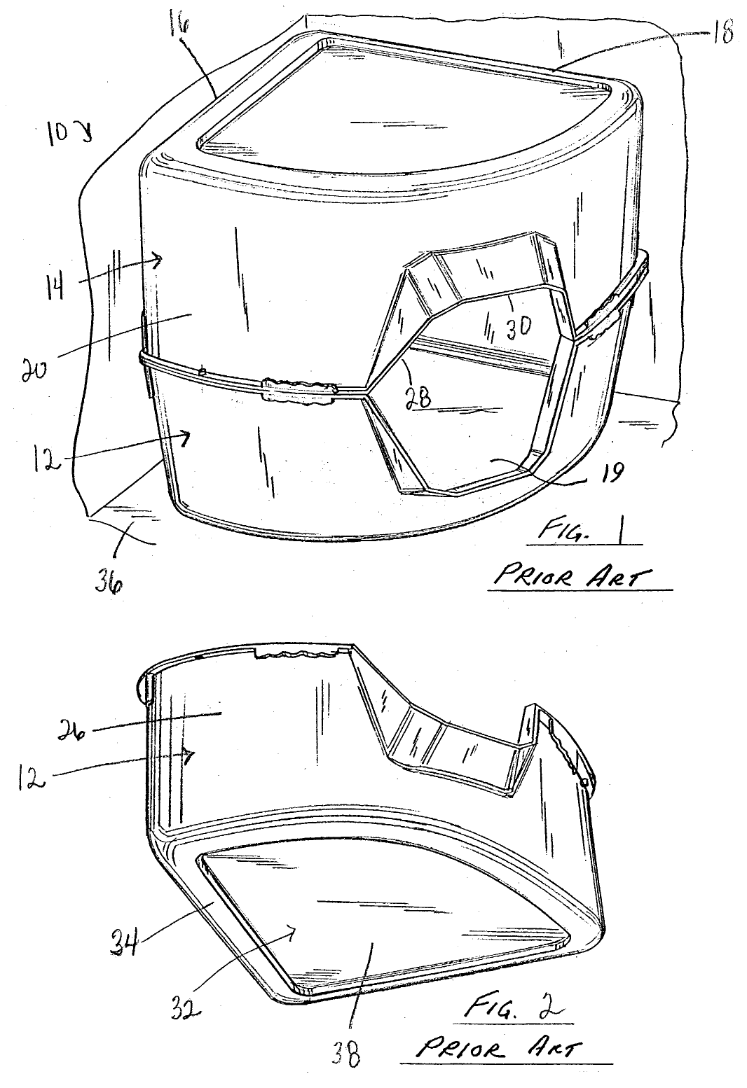

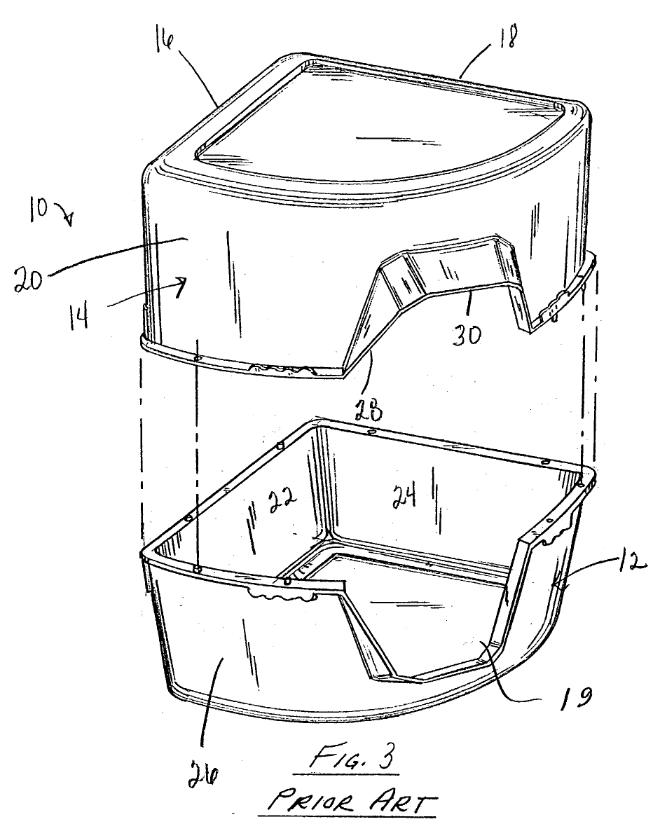

Before explaining embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF AT LEAST ONE PREFERRED EMBODIMENT

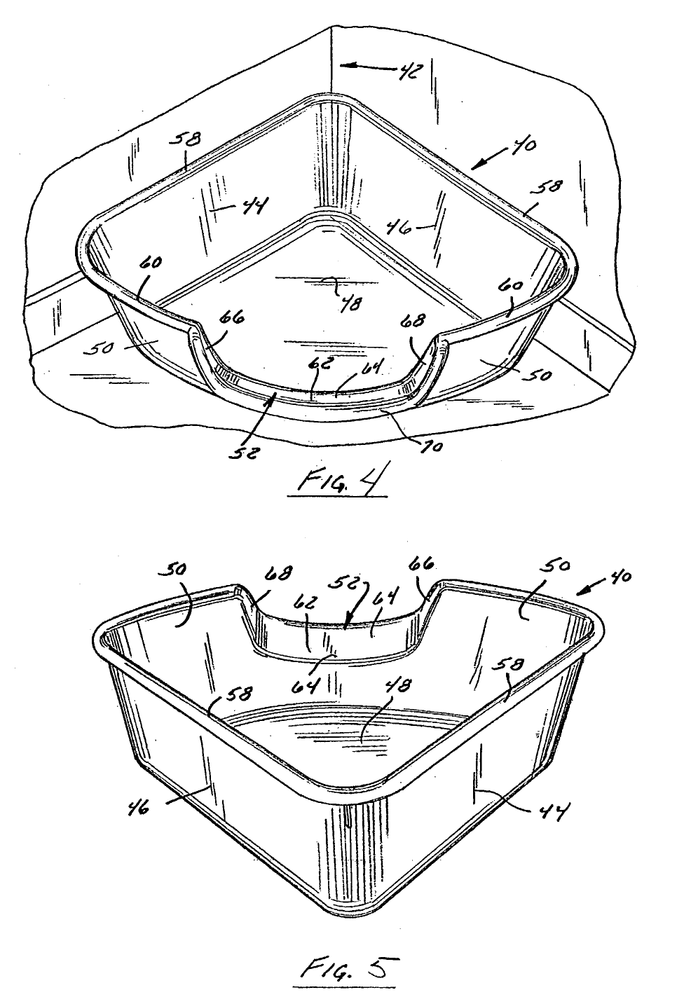

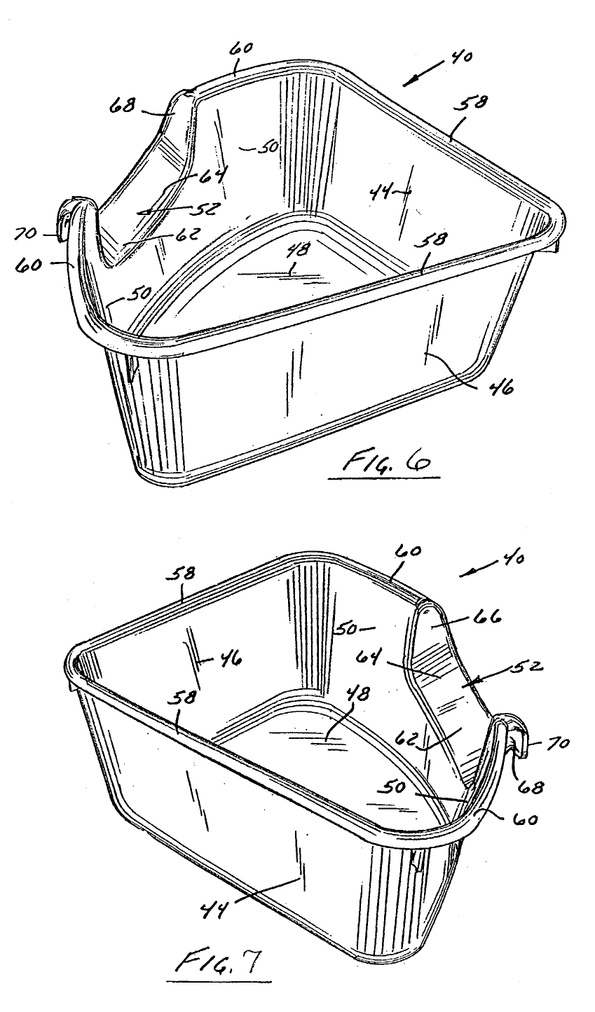

FIGS. 4-7 illustrate a corner cat litter box 40 that is made in accordance with a preferred embodiment of the invention and that is disposed in a corner 42 of a room. A pair of sidewalls 44, 46 extend upwardly from a floor 48 and are disposed generally perpendicularly to each other. A front wall 50 extends outwardly from the floor 48. The front wall 50 extends arcuately from one sidewall 44 to the other sidewall 46 and has a cut-out portion forming an entranceway 52 through which a cat (not shown) can enter and exit.

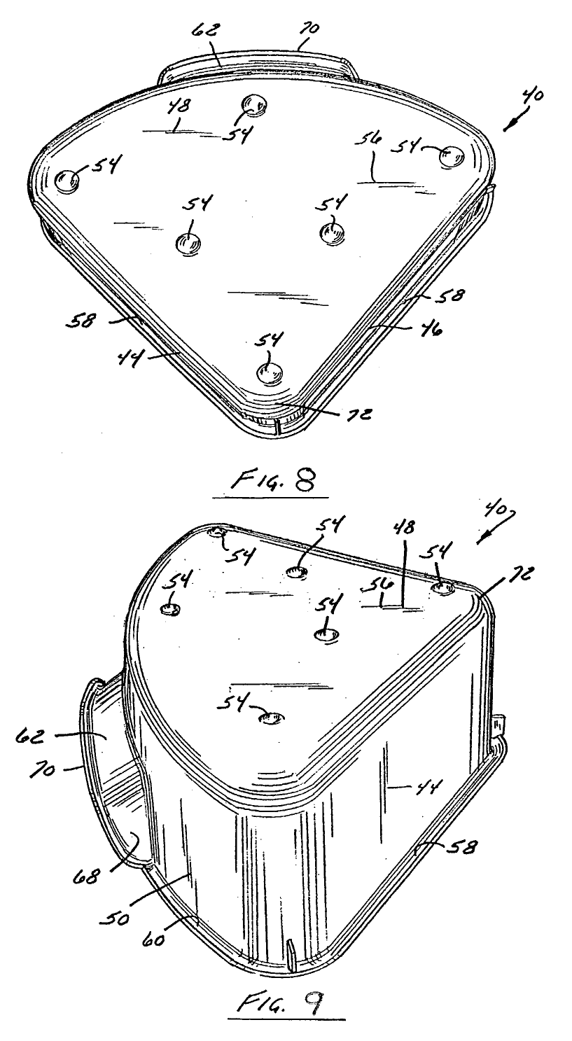

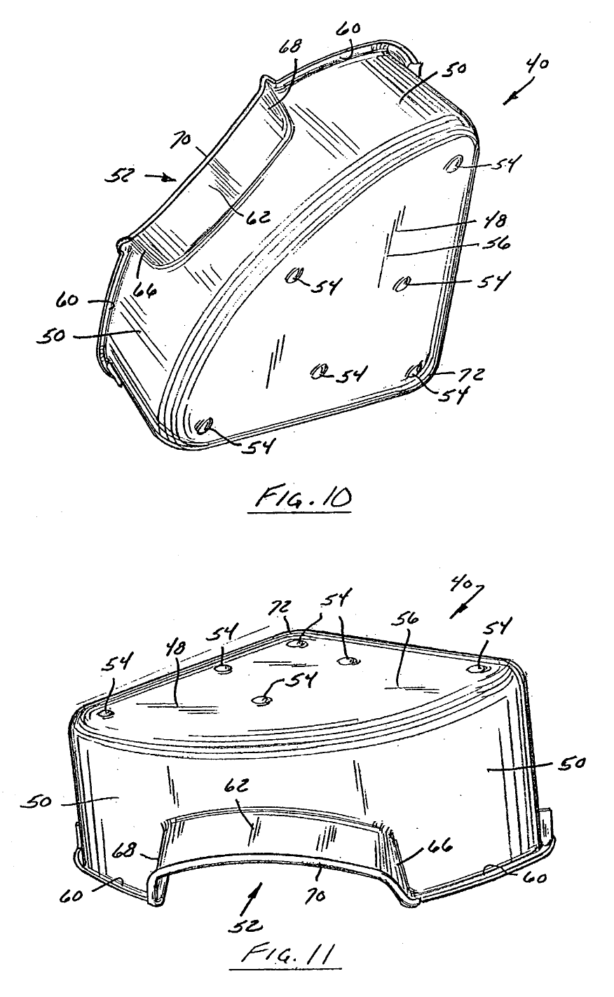

Referring additionally to FIGS. 8-11, an underside 56 of the floor 48 has a plurality of discrete legs 54 that support the underside 56 of the floor 48 from the floor of the room in a spaced-apart fashion. In a preferred embodiment, each leg 54 is integrally formed as part of the floor 48. Each leg 54 comprises a rounded or hemispherical protrusion that is integrally molded into the underside 56 of the floor 48. There is a leg 54 located adjacent each front corner of the floor 48, a leg 54 located in line with and below the entranceway 52, a leg 54 located adjacent the rear corner of the floor 48, and a pair of legs 54 located between the leg 54 adjacent the rear corner of the floor 48 and the legs 54 located adjacent the front corners of the floor 48. Such an arrangement is beneficial as it helps ensure that all of the underside 56 of the floor 48 is spaced from the floor of the room even when the box 40 is relatively full of cat litter and has a cat (not shown) in the box. Additionally, the arrangement of legs 54 shown in FIGS. 8-11 provides uniform support for the floor 48 of the box 40, helping to ensure that the underside 56 of the floor 48 of the box 40 is always spaced from the floor. The legs 54 preferably are sufficiently long to space the underside 56 of the floor 48 at least 1/16 of an inch from the floor. Legs sufficiently long to form spacings or gaps of 1/16″, ⅛″, 3/16″, or even larger are feasible.

Each sidewall 44, 46 is substantially straight and generally parallel to one of the walls of the room when the box 40 is disposed in a corner of the room. To help retain cat litter in the box 40 while permitting the front part of the box 40 to be raised, each sidewall 44, 46 preferably extends above the intended litter line by at least about 1½″ and more preferably at least about 2½″. In the preferred embodiment shown in the drawing figures, each sidewall 44, 46 has a lip 58 that extends outwardly such that it helps ensure that a gap between each sidewall 44, 46 and an adjacent room wall. Each lip 58 is outturned and downturned such that it curls generally downwardly. Each lip 58 also extends along the entire length of the top edge of both sidewalls 44, 46. This lip, in combination with the legs 54 that space the underside 56 of the floor 48 from the floor of the room, helps ensure good ventilation around and underneath the cat litter box 40. The outturned lip 58 helps seal the box 40 against a wall of the room to help return back into the box 40 litter kicked up by a cat in the box 40. As a result, no cover or lid is necessary. Any spills around the cat litter box dry quickly. Preferably, a lip 60 also extends about the top edge of the front wall 50.

The front wall 50 of the cat litter box 40 is curved such that it bows slightly outwardly away from the corner of the room. More specifically, with regard to the preferred embodiment shown in the drawing figures, the front wall 50 extends generally perpendicularly upwardly such that it is within about 15 degrees of being perpendicular to the floor 48.

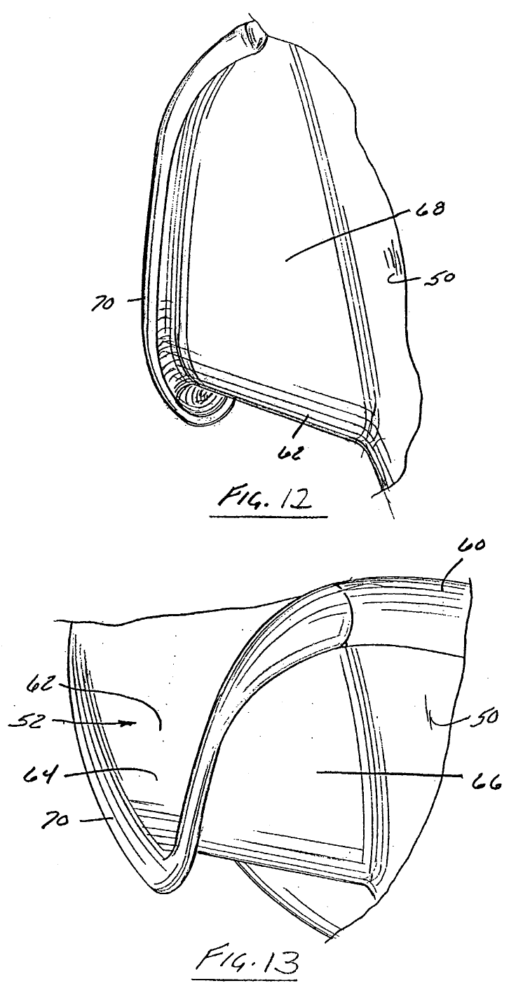

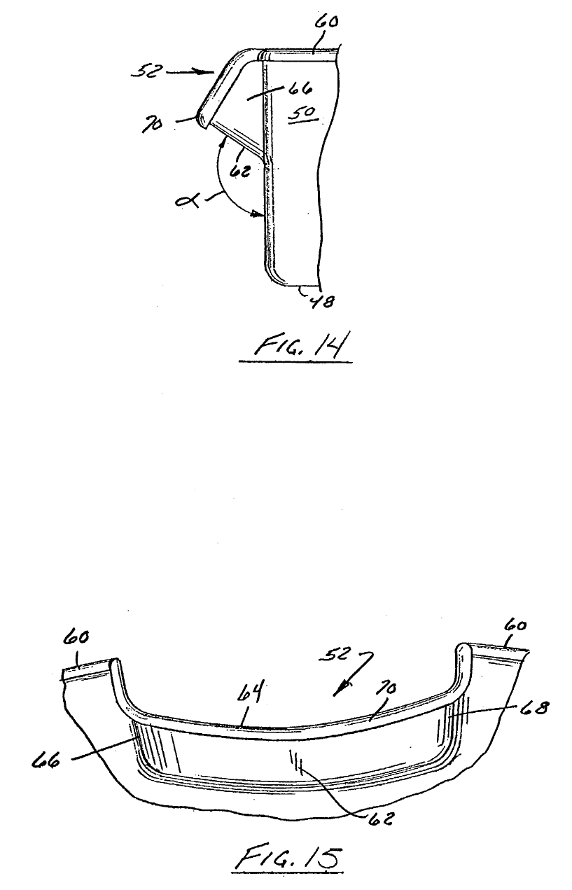

Referring back to FIGS. 4 and 5 and referring additionally to FIGS. 12-17, the entranceway 52 includes a platform 62 that extends outwardly from the front wall 50 away from the interior of the cat litter box 40. The platform 62 is configured to serve as an ingress and egress platform 62. To this end, it is angled relative to the front wall 50 so as to facilitate entry and exit of a cat (not shown) to and from the cat litter box 40. Referring to FIG. 14, the platform 62 forms an obtuse angle, α, with the front wall 50. In one preferred embodiment, the ingress and egress platform 62 is obtusely angled relative to the front wall 50 at an angle, α, of between e.g., about 110 degrees and about 165 degrees, and most preferably of about 135 degrees.

The ingress and egress platform 62 includes a landing surface 64 that is disposed above the intended litter line in the cat litter box 40 and below the top edge of the front wall 50. In the preferred embodiment shown in the drawing figures, the landing is the top surface of the platform that faces toward a cat entering or leaving the box 40. Preferably, the landing 64 is oriented at the same angle as the platform 62. Even more preferably, the landing 64 is oriented at an angle common with the platform 62. Hence, the landing is disposed at an angle of between about 110 degrees and about 165 degrees relative to the front wall 50, and more preferably of about 135 degrees. This orientation helps give a cat (not shown) entering the box 40 leverage to help pull themselves into the box 40 using their front paws. This is particularly advantageous for cats that are elderly or infirm, thereby making it easier for them to enter the box 40. In a preferred embodiment, the highest point of the landing 64 is no higher than about 3″ to about 5″, and more preferably about 5″, off the floor to facilitate ingress and egress. The landing 64 also is preferably curved so as to facilitate redirection of the thrust or momentum of a cat attempting to enter the litter box 40 towards the center of the litter box 40. To facilitate ingress and egress of a cat, the bottom edge of the platform 62 is spaced no more than about three inches above the floor 48 of the box 40. Preferably, the top or outer edge of the platform 62 is spaced at least one inch below the top edge of the front wall 50. In addition, the entranceway 52 is also sufficiently wide relative to the length of the front wall 50 to provide a cat with sufficient freedom of vision to prevent it from feeling enclosed or “boxed in” when it is inside the litter box 40. The entranceway 52 preferably has a width that extends about ⅕^{th} to about ⅓^{rd} the length of the front wall 50. In a box in which the front wall 50 is between about 24″ and about 30″ long, the entranceway 52 should have an average width (as measured along the height of the entranceway) of between about 6″ and about 12″, more preferably of between about 8″ and about 10″, and most preferably of about 9″. Such an arrangement with a low and wide entry makes the entranceway 52 particularly well-suited for aged or infirm cats who have difficulty getting into litter boxes having higher sidewalls. Additionally, it allows the cat to feel secure as it can see outside the box while the box can maintain the previously noted advantages of having high sides.

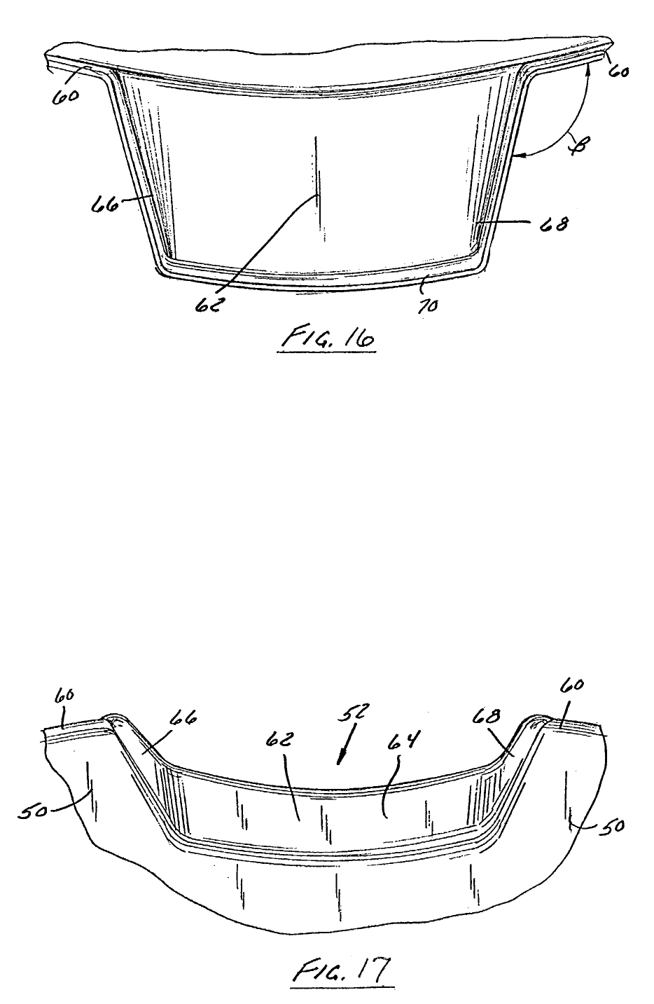

The platform 62 may include a pair of side panels 66, 68 that extend along one edge of the landing 64 to the front wall 50. The side panels 66, 68 help redirect the thrust or momentum of a cat attempting to enter the box 40 at an angle should the cat attempt to enter the box 40 off center toward one edge of the landing 64. If the platform 62 is equipped with side panels 66, 68, each side panel preferably is obtusely angled relative to the front wall 50. Referring to FIG. 16, in one preferred embodiment, each side panel 66, 68 forms an included angle, β, with the exterior surface of the front wall 50. The angle, β, preferably is between about 100 degrees and about 155 degrees, and more preferably is about 135 degrees.

Collectively, the landing 64 and the side panels 66, 68 not only define the ingress and egress platform 62, but they also function as a spout or funnel that helps return cat litter back into the box 40 kicked up by a cat entering or leaving the box. This same spout or funnel arrangement also advantageously facilitates the pouring cat litter from the box 40 when it is desired to remove cat litter from the box 40.

In the preferred embodiment of the cat litter box 40 shown in the drawing figures, the outer edge of the landing 52 has an outturned lip 70 that also functions as a handle. For example, should liquid somehow get onto the floor underneath the cat litter box 40, the handle 70 can be grasped to raise the front portion of the box 40 off of the ground to permit the liquid to be wiped up. This is particularly useful where a cat urinates next to the litter box 40 and urine seeps under the cat litter box 40.

When the inventive box 40 is lifted, the lip 58 along each sidewall 44, 46 rides along one of the walls of the room to support the box 40. This maintains the location of the box 40 in the corner when the box 40 is lowered. In addition, the leg 54 serves as a pivot about which the box 40 rotates when the box 40 is lifted. Maintaining point contact between the leg 54 and the floor helps permit the leg 54 to slide on the floor as the box is lifted. It also helps facilitate pivoting of the rear corner of the box 40. This can be done easily and conveniently without spilling cat litter from the box 40 onto the floor. Thereafter, the front end of the box 40 can be lowered to return it to its original location in the corner of the room. This arrangement also helps to easily move the front end of the box 40 away from the corner of the room, such as when it is desired to empty or clean the box 40.

When it is desired to remove litter in the box 40, the box 40 is pulled away from the corner and lifted. The box 40 is grasped by its sidewalls 44, 46 and tilted such that the front wall 50 is lowered toward the floor of the room. As the front wall 50 is lowered, cat litter will start to move toward the entranceway 52. The curvature of the platform 62 helps channel or direct the litter into another container, such as a garbage can or a garbage bag. The side panels 66, 68 also help direct litter toward the platform 62, where it easily flows out of box 40.

In a preferred embodiment, the box 40 is of molded, one-piece unitary construction. Preferably, the box 40 is molded of a plastic.

It is understood that one or more preferred embodiments are shown and described above to illustrate different possible features of the invention and the varying ways in which these features may be combined. Apart from combining the different features of any of these embodiments in varying ways, other modifications are also considered to be within the scope of the invention.

It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

It is claimed:

1. A cat litter box comprising:
(a) a floor;
(b) first, second, and third sidewalls that extend upwardly from the floor in an at least generally triangular arrangement with the first sidewall being generally perpendicular to the second sidewall so as to permit the cat litter box to be placed in a corner of a room with the first sidewall disposed adjacent to and parallel with one of the walls of the room and the second sidewall disposed adjacent to and parallel with another one of the walls of the room; and
(c) an entranceway that extends outwardly from the third sidewall.

2. The cat litter box according to claim 1, wherein the entranceway comprises an ingress and egress platform formed from an upper end of a reduced height portion of the third sidewall, extends outwardly from the third sidewall.

3. The cat litter box according to claim 2, wherein the ingress and egress platform extends outwardly from the third sidewall.

4. The cat litter box according to claim 2, wherein the ingress and egress platform comprises a handle for facilitating lifting of the cat litter box to permit cleaning of the floor underneath.

5. The cat litter box according to claim 4, wherein the handle of the ingress and egress platform comprises an outturned lip.

6. The cat litter box according to claim 2, wherein the ingress and egress platform comprises a curved bottom panel and a pair of side panels that extend outwardly from the third sidewall.

7. The cat litter box according to claim 6, wherein the ingress and egress platform further comprises an outturned curved lip that extends outwardly from the bottom panel and the side panels.

8. The cat litter box according to claim 7, wherein the outturned curved lip comprises a handle that facilitates lifting of a front end of the cat litter box.

9. The cat litter box according to claim 2, wherein the ingress and egress platform is located no more than about 5″ off a floor of a room on which the cat litter box is supported.

10. The cat litter box according to claim 9, wherein the ingress and egress platform is located about 3″ off the floor of the room.

11. The cat litter box according to claim 9, wherein the entranceway has an average width, as measured along a height of the entranceway, of between about ⅕^{th} and about ⅓^{rd} of a length of the third sidewall.

12. The cat litter box according to claim 2, wherein the entranceway has an average width, as measured along a height of the entranceway, of between about ⅕^{th} and about ⅓^{rd} of a length of the third sidewall.

13. The cat litter box according to claim 2, wherein the entranceway has an average width of between about 6″ and about 12″.

14. The cat litter box according to claim 13, wherein the entranceway has an average width of between about 8″ and about 10″.

15. The cat litter box according to claim 14, wherein the entranceway has an average width of about 9″.

16. The cat litter box according to claim 1, further comprising a plurality of legs that extend downwardly from the floor to support the floor of the room in a spaced-apart relationship.

17. The cat litter box according to claim 16, wherein each of the legs comprises a projection that is integrally molded into the floor of the cat litter box.

18. A cat litter box for placement in a corner of a room comprising:
(a) a floor;
(b) a pair of sidewalls that extend upwardly from the floor with one of the sidewalls being generally perpendicular to the other one of the sidewalls;
(c) a front wall that extends from one of the sidewalls to the other one of the sidewalls; and
(d) an ingress and egress platform that extends outwardly from the front wall, the ingress and egress platform being located no more than about 5″ above a floor of a room on which the cat litter box is supported.

19. The cat litter box according to claim 18, wherein the ingress and egress platform forms an obtuse angle, α, with the front wall.

20. The cat litter box according to claim 18, wherein the obtuse angle, α, is between about 110 degrees and about 165 degrees.

21. The cat litter box according to claim 20, wherein the obtuse angle, α, is about 135 degrees.

22. The cat litter box according to claim 18, wherein the ingress and egress platform includes a landing surface that is disposed above cat litter when cat litter is placed in the cat litter box and below a top edge of the front wall.

23. The cat litter box according to claim 22, wherein the landing surface is oriented at an angle common with the platform.

24. The cat litter box according to claim 23, wherein the landing surface is collinear with the platform.

25. The cat litter box according to claim 23, wherein the landing surface is a top surface of the platform that faces toward a cat entering or leaving the cat litter box.

26. The cat litter box according to claim 23, wherein the landing surface is disposed an angle of between about 110 degrees and about 165 degrees relative to the front wall.

27. The cat litter box according to claim 26, wherein the landing surface is disposed at an angle of about 135 degrees relative to the front wall.

28. The cat litter box according to claim 18, wherein the ingress and egress platform includes a pair of side panels that extend along one edge of the landing surface to the front wall.

29. The cat litter box according to claim 28, wherein each side panel is obtusely angled relative to the front wall.

30. The cat litter box according to claim 28, wherein each side panel forms an included angle, β, with the exterior surface of the front wall of between about 100 degrees and about 155 degrees.

31. The cat litter box according to claim 30, wherein each side panel forms an included angle, β, with the exterior surface of the front wall of about 135 degrees.

32. The cat litter box according to claim 18, wherein a bottom edge of the ingress and egress platform is spaced no more than about three inches above the floor.

33. The cat litter box according to claim 32, wherein a top or outer edge of the ingress and egress platform is spaced at least one inch below a top edge of the front wall.

34. A cat litter box for placement between a first wall and a second wall of a room that define a corner of the room comprising:
(a) a floor having a plurality of discrete legs that space the floor of the room; and
(b) a plurality of sidewalls extending upwardly from the floor of the cat litter box to form an enclosure.

35. A cat litter box of claim 34, wherein one of the sidewalls is generally parallel to the first wall of the room and generally perpendicular to another one of the sidewalls, and another one of the sidewalls is generally parallel to the second wall of the room; and
a front wall that extends from one of the sidewalls to another one of the sidewalls.

36. A cat litter box of claim 35, further comprising an ingress and egress platform that extends outwardly from the front side wall.

37. A cat litter box according to claim 34, wherein each leg is integrally formed as part of the floor.

38. A cat litter box according to claim 34, wherein each leg comprises a rounded or hemispherical protrusion that is integrally molded into the underside of the floor.

39. A cat litter box according to claim 34, wherein
a first leg is located adjacent a first front corner of the floor,
a second leg is located adjacent a second front corner of the floor,
a third leg located adjacent a rear corner of the floor,
a fourth leg is located in line with and below the ingress and egress platform, and
fifth and sixth legs are located between 1) the first leg and the second legs and 2) the third leg.

40. A cat litter box according to claim 34, wherein the legs space the underside of the floor at least about 1/16 of an inch above the floor of the room.

41. A cat litter box according to claim 34, wherein each of the legs protrudes downwardly from the underside of the floor by at least about ⅛ of an inch.

42. A cat litter box according to claim 41, wherein each of the legs protrudes downwardly from the underside of the floor by at least about 3/16 of an inch.

43. A cat litter box for placement in a corner of a room comprising:
(a) a floor;
(b) a pair of sidewalls that extend outwardly from the floor with one of the sidewalls being generally perpendicular to the other one of the sidewalls, wherein each sidewall has a lip that extends outwardly therefrom;
(c) a front wall that extends from one of the sidewalls to the other one of the sidewalls; and
(d) an ingress and egress platform that extends outwardly from the front wall.

44. A cat litter box according to claim 43, wherein each lip is outturned and downturned such that it curls generally downwardly.

45. A cat litter box according to claim 43, wherein each lip extends along an entire length of a top edge of both sidewalls.

46. A cat litter box according to claim 43, wherein a lip extends about a top edge of the front wall.

47. A cat litter box according to claim 43, wherein the front wall extends generally perpendicularly upwardly from the floor such that it is within about 15 degrees of being perpendicular to the floor.

48. A cat litter box that is disposed between a first wall and a second wall of a room that define a corner of the room, the cat letter box comprising:
(a) a floor having a plurality of discrete legs that space the floor from a floor of the room;
(b) first and second sidewalls that extend outwardly from the floor with the first sidewall being generally parallel to the first wall of the room and generally perpendicular to the second sidewall and the second sidewall being generally parallel to the second wall of the room;
(c) a curved front wall that extends from the first sidewall to the second sidewall;
(d) an ingress and egress platform that extends outwardly from the front wall, the ingress and egress platform having an outwardly extending lip that defines a handle for lifting the cat litter box.
